(19) United States
(12) Patent Application Publication
(10) Pub. No.: US 2016/0180275 A1
(43) Pub. Date: Jun. 23, 2016

(54) METHOD AND SYSTEM FOR DETERMINING A SITE PERFORMANCE INDEX

(71) Applicant: Medidata Solutions, Inc., New York, NY (US)

(72) Inventors: Richard Piazza, Hasbrouck Heights, NJ (US); Christopher Bound, Perkasie, PA (US); Joshua Hartman, Fort Washington, PA (US)

(21) Appl. No.: 14/575,769

(22) Filed: Dec. 18, 2014

(51) Int. Cl. G06Q 10/06; G06Q 50/22; G06F 19/00

(52) U.S. Cl. CPC G06Q 10/06393; G06F 19/363; G06Q 50/22

(57) ABSTRACT

A method for determining a site performance index includes receiving data from one or more clinical trial sites, associating the clinical trial site data with at least one site performance factor, calculating a weighting value for the site performance factor, and generating the site performance index based on the weighted site performance factor. An apparatus for determining a site performance index is also described and claimed and includes a site data filter, a data stream analyzer, and an aggregator.

### BACKGROUND

Different entities involved in a clinical trial, such as sponsors (e.g., drug manufacturers), hospitals, doctors (principal investigators), and contract research organizations (“CROs”), are interested in recruiting investigative sites that will deliver good performance for their clinical trial. A site performance index (“SPI”) measures or quantifies the performance of an investigative site (or “site”). A comprehensive and realistic SPI is therefore valuable so that the different entities may recruit and select better performing sites.

### BRIEF DESCRIPTION OF THE DRAWINGS

FIG. 1A is a block diagram of a system for calculating an SPI for a clinical site, according to an embodiment of the present invention;

FIG. 1B shows parts of the system of FIG. 1A in more detail, including database 20 and data pre-processor and analyzer 50;

FIG. 2 is a flowchart showing a method for calculating an SPI, according to an embodiment of the invention;

FIGS. 3A-3C provide examples of tables for calculating the SPI for a particular site, according to an embodiment of the present invention;

FIG. 4 shows an example of a table for a scoring scheme for the number of actual points obtained for each factor;

FIG. 5A is a block diagram of an SPI calculator that may implement the factors shown in FIGS. 3A-3C and 4; and

FIG. 5B shows another embodiment of the SPI calculator, that includes only the enrollment analyzer and calculation.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Embodiments of the present invention may be used in a variety of applications. Although the present invention is not limited in this respect, the systems and methods disclosed herein may be used in or with clinical drug, biologic, or device trials, monitoring of sales operations and associates, monitoring of retail services and locations, and other data-intensive applications in which users may desire to assess quickly the quality of a site or group of sites. For example, it may be appreciated that the present invention could be utilized in sales, retail, or franchise organizations, wherein the quality of data generated by remote offices or individuals in compliance or conjunction with a centralized office or rules could be monitored or assessed.

A clinical trial (also called a clinical study, an interventional study, or, as used herein, a study or a trial) is typically directed to a specific therapeutic area, and may be categorized by phase. In a Phase I clinical trial, the drug, biologic, or device may be tested on approximately 20 to 100 volunteers (also known as patients or subjects) in order to gather clinical data on safety and dosage; in Phase II, clinical data may be gathered from approximately 100 to 500 volunteers in order to gather clinical data on efficacy and side-effects; and in Phase III, clinical data may be gathered from approximately 500 to 3000 or more volunteers in order to collect definitive evidence of safety and efficacy to obtain marketing approval of the drug or device.

A pharmaceutical company, an academic research center, a federal agency, or a clinical research center typically sponsors a clinical trial. The sponsor or its CRO (a person or an organization—commercial, academic, or other—contracted by the sponsor to perform one or more of a sponsor's trial-related duties and functions) generally selects the locations, known as investigative sites, at which the clinical trial will be conducted. Sites typically may be hospitals, clinics, universities, doctors' offices, research institutions, or corporate trial locations. Over the course of a clinical trial, the principal investigator (“PI”) or other personnel at the site are typically responsible for recording data, including information about the subjects and clinical data. Data captured by the PI or other site personnel are entered manually into case report forms (CRFs) or into electronic CRFs (eCRFs) hosted on electronic data capture (EDC) systems. However, clinical data collected for the purpose of the clinical trial is typically first recorded into a site-specific source such as a paper-based patient chart or electronic medical record system prior to being transcribed into the EDC system being utilized for the clinical trial. Such manual transcription may lead to accidental data errors. In addition, a site may be fraudulently entering incorrect clinical data or otherwise deviating from good clinical practice or from the study protocol.

Entities such as sponsors and CROs may be looking for investigative sites that will deliver the desirable performance or results for clinical trials. Thus, sites may be selected based on a variety of selection factors. Examples of such factors may include whether the potential site has a key opinion leader (“KOL”) as a principal investigator, whether the site has a large patient population, and whether the per-patient budget proposed by the site is low. Information relating to such factors may be self-reported through questionnaires, or may be available publicly, sometimes through government sources. It may be beneficial for the sponsor to quantify and measure the factors and the overall appropriateness or desirability of potential sites in the selection process.

A site performance index (“SPI”) may be utilized to quantify the appropriateness or desirability of a potential site to be selected. An SPI may take into account specific factors that are relevant to the site selection to achieve the desirable performance for the clinical trial. A site performance index apparatus may be a rating system that scores investigators/sites based on numerous factors and performance metrics, by taking advantage of system generated information, which may be real time and performance related, while incorporating other site profile factors (e.g. therapeutic area) to create a more complete picture of the investigator/site.

An SPI may be determined by assigning a score to each of the factors considered in the site selection process. However, such a scoring scheme does not allow the interested party, such as a sponsor, to prioritize a particular factor or to assign a higher weight to a factor in determining the SPI, as the priority factors may not come from a static profile, but rather may be derived through use of typical eClinical systems. In other words, such an SPI methodology does not allow those searching for the most desirable sites to weigh the importance of the various factors in an easy, automated way based on the interested party's most desirable operational requirements. For example, Study A and Study B may have very different operational requirements:
Study A Priorities: Rapid enrollment
   Short FPFV (first patient, first visit) to LPLV (last patient, last visit) time
   Site has performed many clinical trials
Study B Priorities: Data entered in EDC ASAP after subject visit
   Low to moderate site costs
   EDC experience

Each trial may have its own criteria and priorities associated with those criteria, which may make a site more or less suitable for the particular trial. These priority factors may come from a static site profile. These priority factors may also be derived through the use of an eClinical system.

A method and a system for determining a useful SPI have been developed by incorporating the flexibility to assign different weights to multiple site performance factors, which also may be associated with factor categories such as financial, subject pool and enrollment history, timeliness, quality, and experience, among others. The site performance factors associated with these categories may include:

Financial
The percentile into which a site's Per Patient Budget most frequently falls
The percentile into which a site's Per Patient Budget falls (across all trials for that site)>50% of the time
The Budget Percentile into which a site falls out of all sites within the same trial
The Budget Percentile into which a site falls out of all sites compared to an industry benchmark

Subject Pool and Enrollment History
Overall percentage achievement of Enrollment Target
Site meets certain percentage of the Enrollment Target>50% of the time
Subject Retention Rate (Avg. % of Subjects lost to follow up (LTFU))
Average First Patient First Visit (FPFV)-->Last Patient First Visit (LPFV) compared to industry benchmark

Timeliness
Average Time from Subject/Patient Visit to Data Entry
Average Time to Respond to Query

Quality
Average # of System Queries per Subject/Patient
Average # of Manual Queries per Subject/Patient

Experience
Clinical Trial Experience—no. of previous trials
Experience with EDC
Experience with specific programs such as Medidata Clinical Cloud

The site performance factors may be filtered based on other factors (“filtering factors”) such as type of site (whether it is a clinical research center, private practice, or academic), geography (based on countries or U.S. metropolitan regions), the claimed patient population for a given indication, clinical trial experience (either in the therapeutic area or based on indications), and the specialty of the principal investigator.

Non-clinical data may be taken into account in determining an SPI. Such non-clinical data may include metadata present in electronic systems employed in clinical trials. An example of such metadata is the average time spent by a candidate site to respond to query.

The factors may be sourced through e-clinical systems, such as EDC systems, clinical trial management systems (“CTMS”), interactive voice/web response systems (“IxRS”), budgeting systems, and grant management systems. In another embodiment, the factors may be manually entered. In yet another embodiment, publicly available data, which may include Form 1572 filings, may be considered for use.

Embodiments of the present invention may include development of metrics concerning dynamically extracting and associating site data with site performance factors, assigning a numerical weight to each site performance factor calculated by a user and/or by the system, and filtering site data based on site performance factors. Other embodiments may aggregate real-time and historic site data in order to generate a site performance index in real time based on the weighted site performance factors.

The relative importance given to any parameter may be made variable by allowing the user to apply a weighting to each factor. The SPI may range from 0 to 100, where a higher score may indicate a better fit for the user's requirements. This may provide the site recruiter with more useful data to aid the selection process than a standard profile (e.g., therapeutic area of expertise, years of experience, competing trials) may offer.

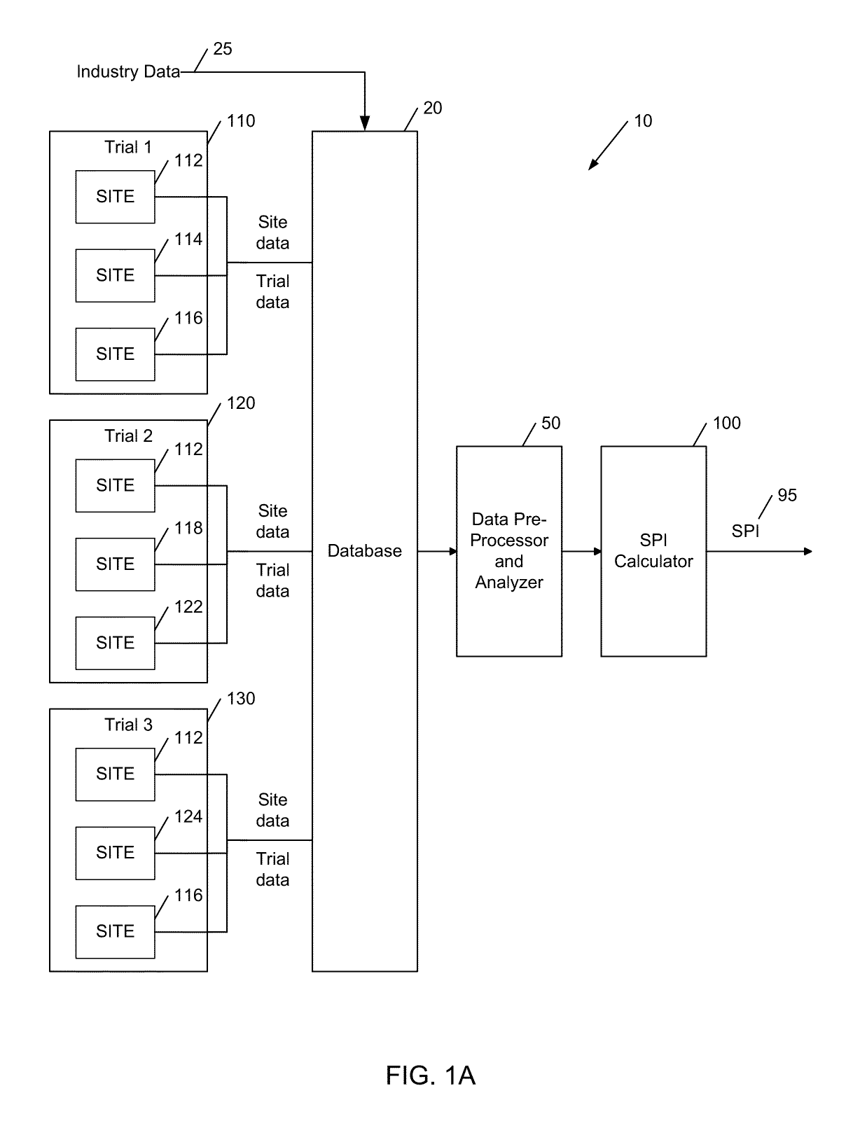

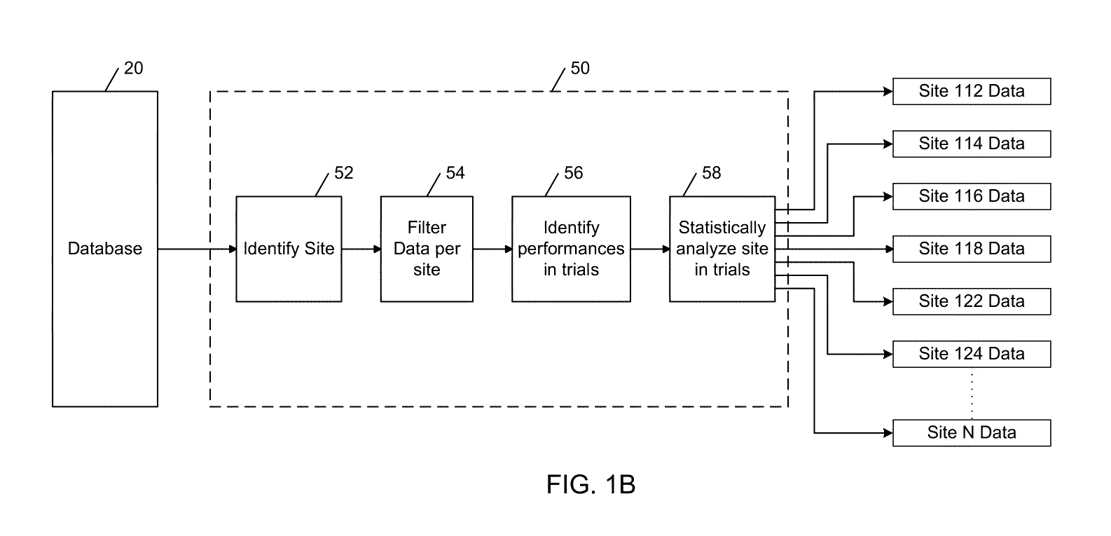

Reference is now made to FIG. 1A, which is a block diagram of a system 10 that includes a Site Performance Index (SPI) Calculator 100 according to an embodiment of the present invention. Data may be generated during various clinical trials, e.g., Trial 1 110, Trial 2 120, Trial 3 130, and the data collected from sites at those trials, e.g., sites 112, 114, 116, 118, 122, 124, may be stored in a database 20, along with industry data 25. Sites may participate in more than one trial. The data in the database may be transmitted to a data pre-processor and analyzer 50, which may identify sites and trials and statistically analyze the performance of the sites in the various trials against other sites and against industry data. Each site can then be evaluated using SPI calculator 100 to determine that site's site performance index 95.

FIG. 1B shows parts of system 10 in more detail, including database 20 and data pre-processor and analyzer 50. Data, which may include site data, trial data, and industry data, may be transmitted from database 20 to data pre-processor and analyzer 50. Data pre-processor and analyzer 50 may identify each site 52, filter the data for each site 54, identify the performance of each site in the trial(s) in which the site participated 56, and statistically analyze each site 58 compared to other sites in those trials. The data may be exported by site, e.g., site 112 data, site 114 data, etc., for use in SPI calculator 100.

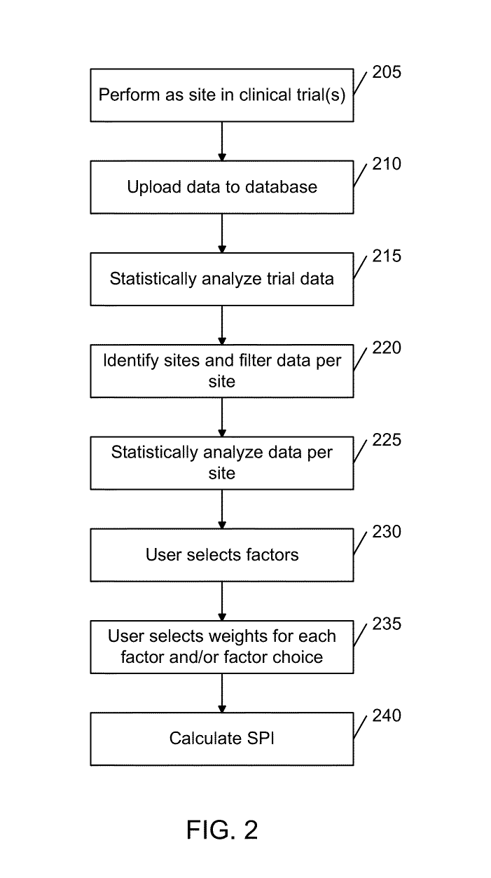

FIG. 2 shows a flowchart of the whole process, according to an embodiment of the invention. In operation 205, a site performs in a clinical trial. In operation 210, the data from the site may be uploaded to database 20. In operation 215, data pre-processor and analyzer 50 may begin to analyze trial data, that is, data from all of the sites in all of the trials in database 20. In operation 220, data pre-processor and analyzer 50 may identify specific sites and filter the data for each site. In operation 225, data pre-processor and analyzer 50 may statistically analyze the data per site in order to determine what factors may be usable for site selection and for calculation of site performance index 95. In operation 230, a user of the system who wants to choose sites for a clinical trial may select factors used to evaluate the sites. In operation 235, the user may select the weights for the factors and/or factor choices. This operation will be explained in more detail below. Finally, SPI calculator 100 may calculate each site's site performance index 95.

Besides the operations shown in FIGS. 1B and 2, other operations or series of operations are contemplated to calculate an SPI. For example, uploading data to the database may include other operations by the sites and may not be performed at one time, e.g., the uploading may be done daily or weekly. Such uploading may be done via a network connection, such as the Internet or via Wi-Fi or a public or private telephone network. Such uploading may be automatic, performed as part of maintenance or as part of an EDC, CTMS, or grant management system, or may be manual, e.g., by manually transferring site data files to the database. The uploading and analysis may be done in real-time, so that a user may re-evaluate site performance even during a trial. Moreover, the actual orders of the operations in the flow diagrams in FIGS. 1B and 2 are not intended to be limiting, and the operations may be performed in any practical order. For example, the analysis of data per site (operation 225) may be performed before the trial analysis (operation 215) is performed or completed, and the selection of the factors and factor weights may be performed at an earlier time, or may be set for a specific user once and then maintained.

In determining SPI 95, a maximum number of points (or score) assigned for each factor category (“category”) may be determined, either by the system or by a user. The maximum score assigned for each category may be the total of all of the maximum scores assigned to all of the factors within that category.

The maximum score assigned for each factor within a particular category may also be determined, again either by the system or by a user. The maximum score assigned for each factor may be the highest possible (maximum) score that a particular factor may receive. Furthermore, the sum of all of the maximum scores assigned to all of the factors may be the maximum score assigned for a particular category that includes all such factors.

The score obtained for each category for a particular site may be determined by, for example, a pre-determined scoring scheme for each factor, which is illustrated below. The total of all the points obtained for all factors may be determined in order to calculate SPI 95. Such a determination may be performed, for example, according to the following summation:

Σwᵢfᵢ

where wᵢ is the weighted site performance factor, which may correspond to the score for factor fᵢ. Initially, the weighting, which may be the score for each category, may be selected by the user, where the maximum total across all categories is 100 points or 100%. In another embodiment, the weighting for a specific site performance factor may be automatically generated by the system, or may default to a system-designated default value.

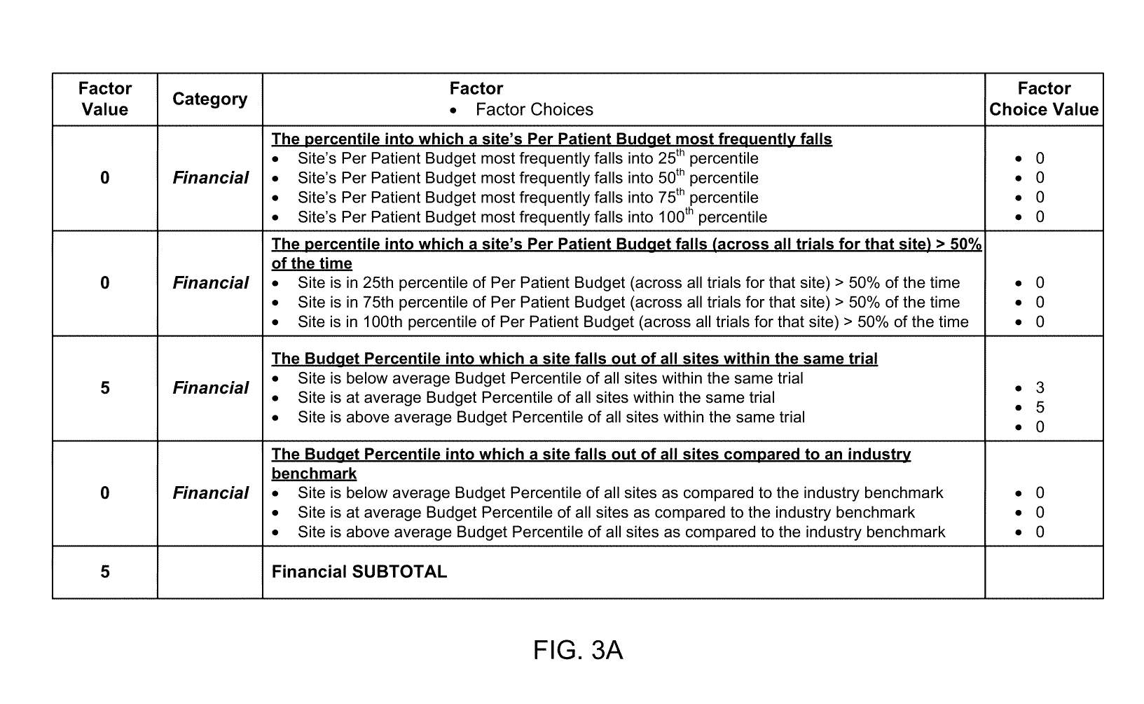

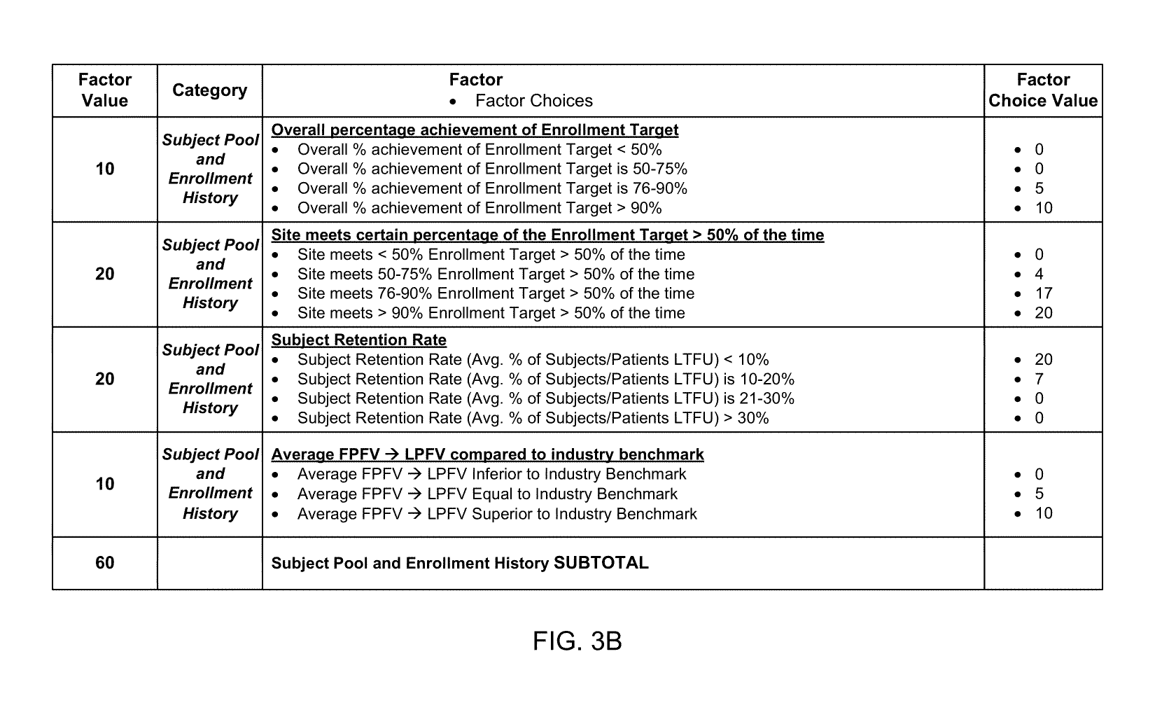

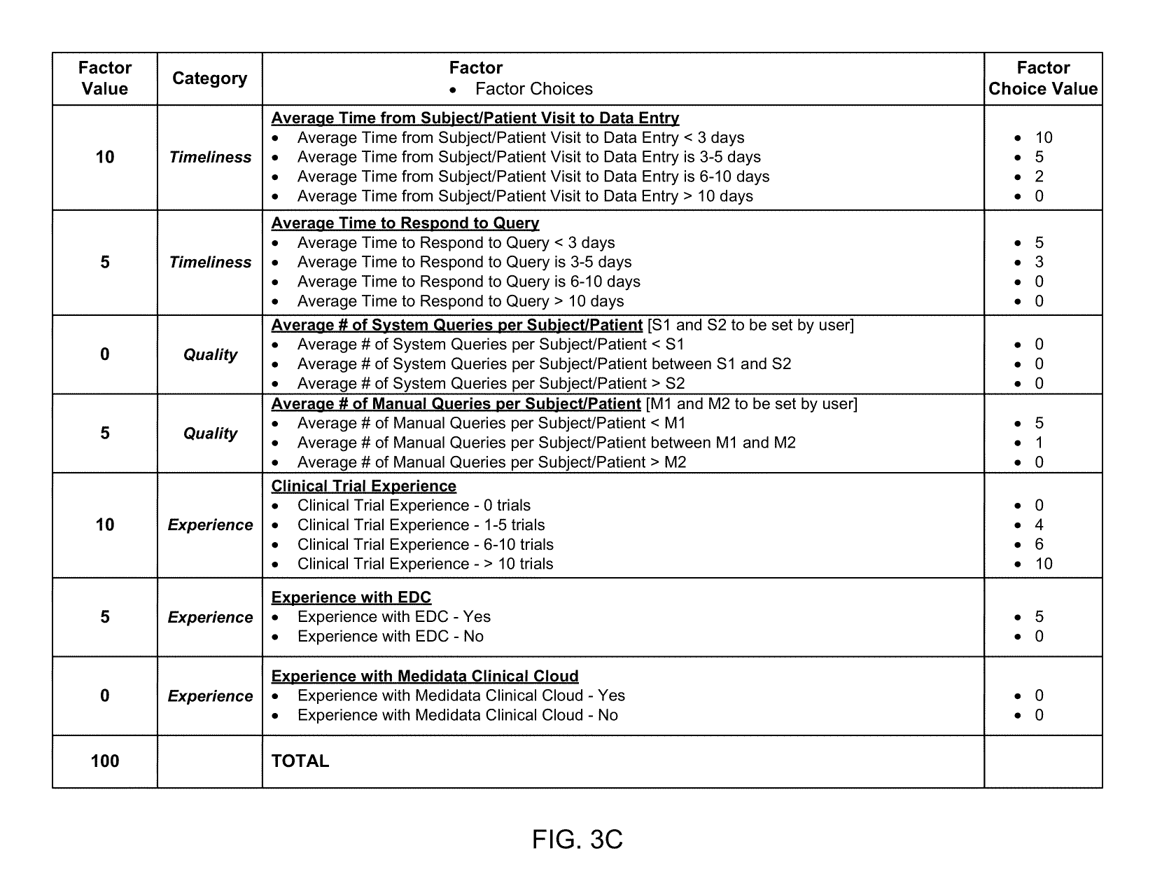

FIGS. 3A-3C show various factor categories and factors that may be considered in calculating an SPI. The categories listed include financial, subject pool and enrollment history (sometimes shortened to “enrollment history”), timeliness, quality, and experience, and the factors listed are those mentioned before for these categories. The categories and factors shown in FIGS. 3A-3C are only examples of the possible categories and factors that are contemplated by the present invention, and others may be used by different entities engaging with the system.

The tables in FIGS. 3A-3C include the category name, the factor name and various choices for the factor, the factor value, and the factor choice value. The factor choice value is the value or score or number of points assigned to each factor choice. The factor value is typically equal to the highest factor choice value for each factor. IF the factor value equals zero, that factor is not considered in calculating the SPI. The factor choice values, and thus the factor values, may be chosen by the user of the system, e.g., the sponsor, CRO, or site personnel, or by the provider of the system as a default. By varying the factor choice and factor values, different entities may assign different weights to the factors and categories.

Referring to the table in FIG. 3A, the first row is the percentile into which a site's Per Patient Budget most frequently falls, and there are four percentile choices—25th, 50th, 75th, and 100th. In this example, no points are assigned to this factor, but in other scenarios or embodiments points may be assigned to one or more of these factor choices. And although four percentile choices are shown, more of fewer could be used, depending on the desired granularity of the SPI calculation.

In FIG. 3A, the factors (1) the percentile into which a site's Per Patient Budget falls (across all trials for that site)>50% of the time and (2) the Budget Percentile into which a site falls out of all sites compared to an industry benchmark are also not assigned any points. But the third factor, the Budget Percentile into which a site falls out of all sites within the same trial, is assigned a maximum of five total points, divided as follows: if the site is below the average Budget Percentile of all sites within the same trial, the factor is worth 3 points, if the site is at the average Budget Percentile of all sites within the same trial, the factor is worth the maximum 5 points, and if the site is above the average Budget Percentile of all sites within the same trial, the factor is worth 0 points. In other embodiments, other point values may be awarded if, for example, being below budget is more important for the user than the other factor choices. Based on the four factors shown in FIG. 3A, the Financial category is worth a maximum of 5 points out of 100, so it is weighted as 5% of the total SPI.

FIG. 3B shows factors and factor choices for the Subject Pool and Enrollment History category. The table is laid out the same as in FIG. 3A, but here all four factors are counted in the SPI. The first factor, overall percentage achievement of Enrollment Target, is worth a maximum of 10 points; the second factor, the site meets a certain percentage of the Enrollment Target>50% of the time, is worth a maximum of 20 points; the third factor, the subject retention rate, is worth a maximum of 20 points, and the fourth factor, the average FPFV→LPFV compared to industry benchmark, is worth a maximum of 10 points. Notice that not every factor choice has a point value—again, this is a reflection of how much that factor choice should be weighted (or considered at all) in the SPI calculation. Based on the four factors shown in FIG. 3B, the Subject Pool and Enrollment History category is worth a maximum of 60 points out of 100, so it is weighted as 60% of the total SPI.

FIG. 3C shows the factors and factor choices for three more categories: Timeliness, Quality, and Experience. The maximum factor values for each factor as well as the factor choice values are shown in FIG. 3C, and based on the point values, the weights that the user is assigning each factor choice can be discerned. In these three categories, Timeliness is worth a maximum of 15 points, Quality is worth a maximum of 5 points, and Experience is worth a maximum of 15 points. Overall, the point values for the five categories (5+60+15+5+15) that contribute to the SPI are worth a maximum of 100 points.

In some cases, the user may be able to input more than just factors and weights, but may also be able to define the values used to distinguish among factor choices. For example, in FIG. 3C, the limits of the quality factors Average Number of System Queries and Average Number of Manual Queries per Subject/Patient may be selected by the user. If a user wants a site with less than a certain number of system or manual queries, the user can set that number to be S1 or M1, respectively. Similarly, if the user wants a site (or maybe wants to avoid a site) with more than a certain number of system or manual queries, the user can set that number to be S2 or M2, respectively. (The numbers S1 and M1 may be equal, as may the numbers S2 and M2.) For example, one user may be satisfied if the Average Number of Manual Queries is less than 40, while another may be satisfied if the number is less than 10.

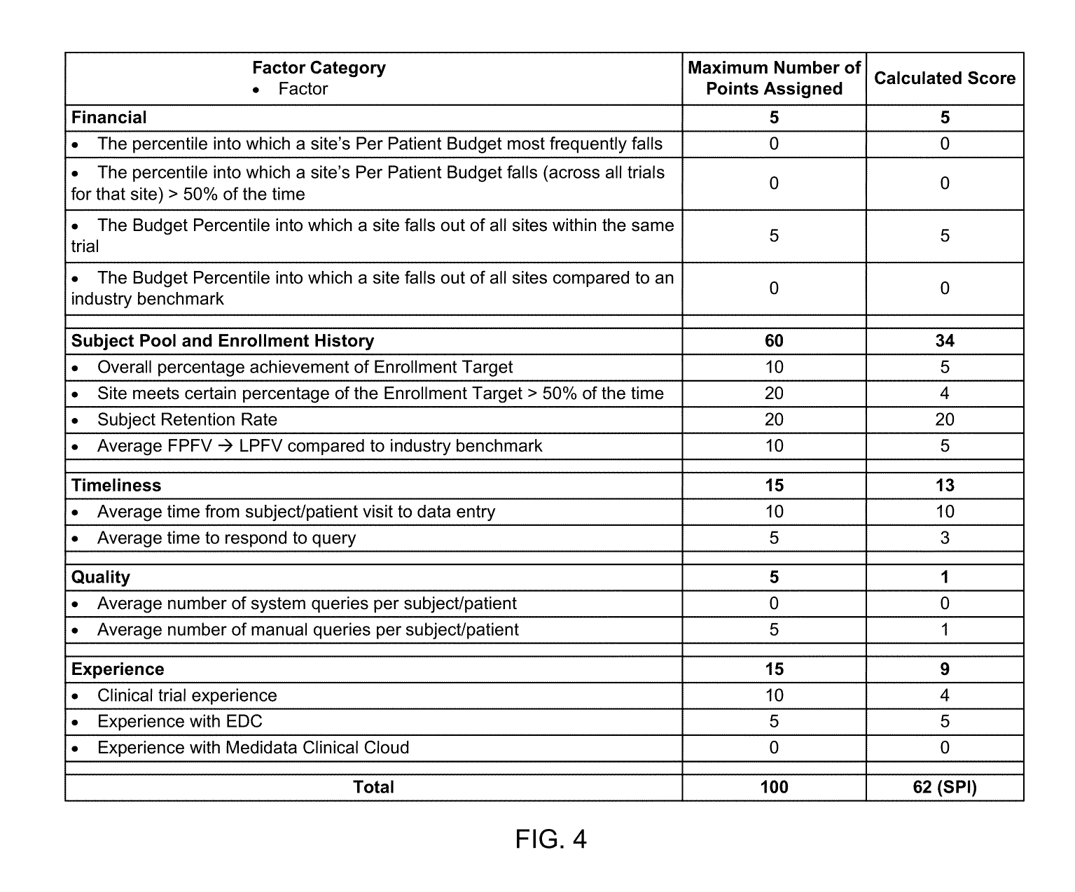

FIG. 4 illustrates an example of an SPI calculation, based on the factor choice values shown in FIGS. 3A-3C. The first column shows the factor category and the factor, the second column shows the maximum number of points assigned, and the third column shows the calculated score based on the factor choice selected. The first, second, and fourth factors were assigned 0 points, so they do not contribute to the calculation in this embodiment. The third factor, the Budget Percentile into which a site falls out of all sites within the same trial, scored the maximum 5 points because the site was at the average Budget Percentile of all sites within the same trial (see FIG. 3A).

The factors within the Subject Pool and Enrollment History category scored 34 points out of the maximum 60 points. Referring back to FIG. 3B, the factor choices selected were Overall % achievement of Enrollment Target is 76-90% (5 points/10); Site meets 50-75% Enrollment Target>50% of the time (4 points/20); Subject Retention Rate (Avg. % of Subjects/Patients LTFU)<10% (20 points/20); and Average FPFV LPFV Equal to Industry Benchmark (5 points/10).

Similarly, the factors within the Timeliness category scored 13 points out of the maximum 15 points, the factors within the Quality category scored 1 point out of the maximum 5 points, and the factors within the Experience category scored 9 points out of the maximum 15 points. Referring back to the factor choice values shown in FIG. 3C, the following factor choices were selected: Average Time from Subject/Patient Visit to Data Entry<3 days, Average Time to Respond to Query is 3-5 days, Average # of Manual Queries per Subject/Patient between thresholds (M1 and M2) set by the user, Clinical Trial Experience—1-5 trials, and Experience with EDC—Yes. The total score at the bottom of FIG. 4, which is the SPI, is 62 points (5+34+13+1+9).

The factor categories are not limited to the ones shown in FIGS. 3A-3C and 4. As mentioned above, other factor categories may be possible, including the type of site, geography, claimed patient population for given indication, clinical trial experience in terms of the therapeutic area, clinical trial experience in terms of indications, and the specialty of the principal investigator.

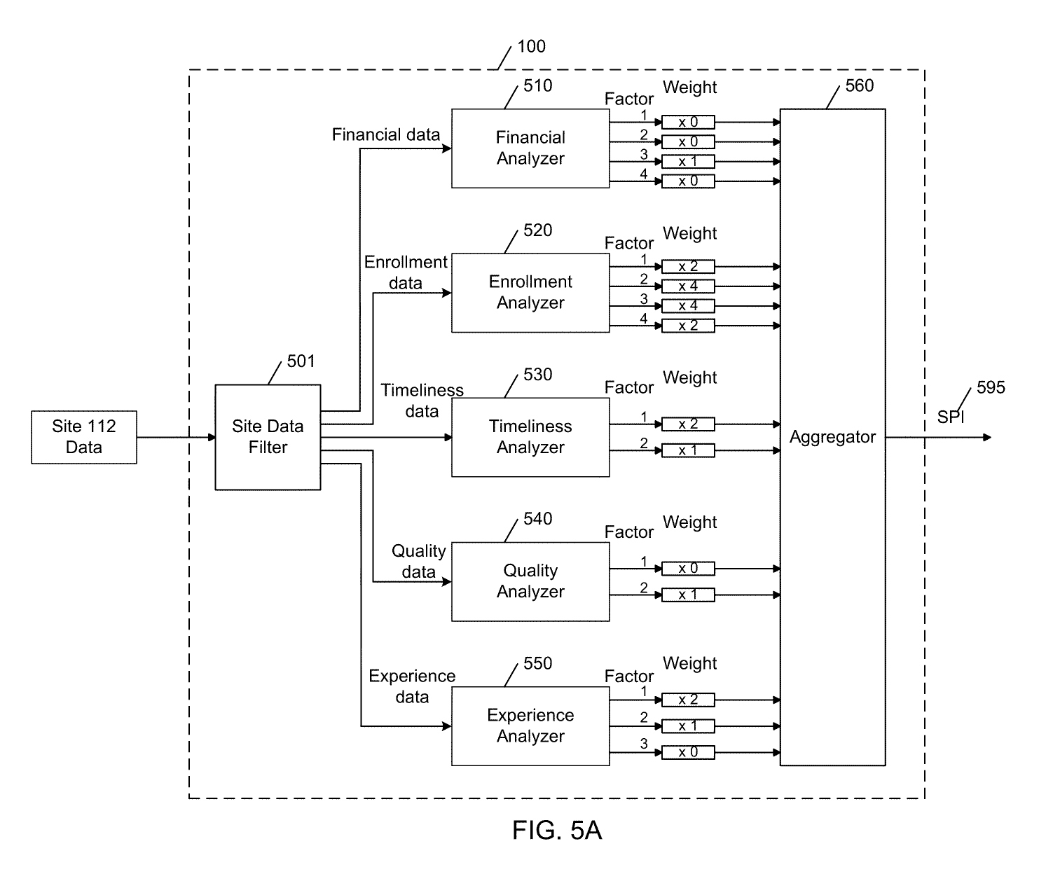

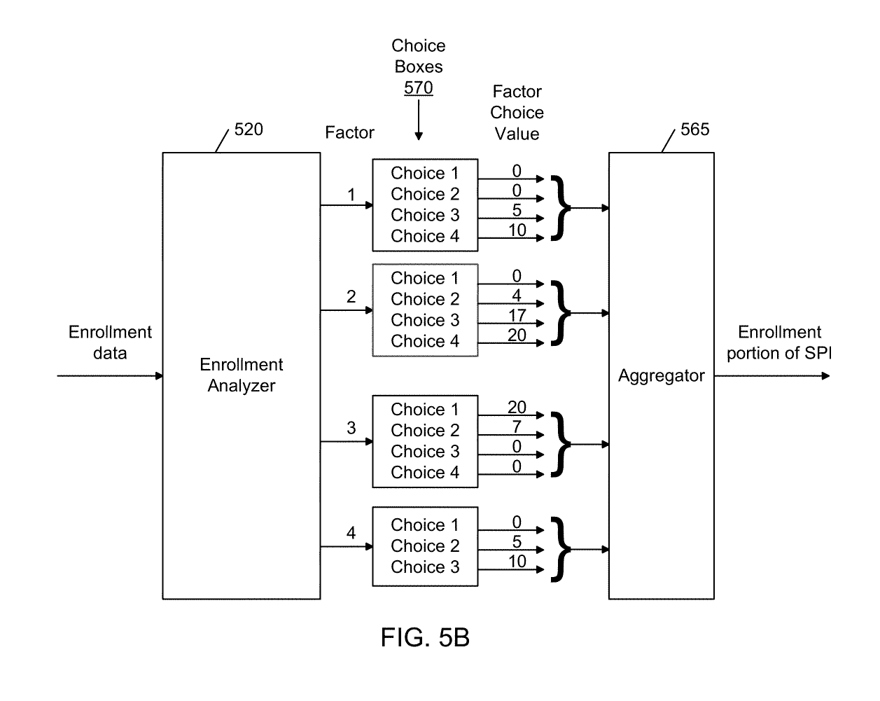

FIG. 5A is a block diagram of an SPI calculator that may implement the factors shown in FIGS. 3A-3C and 4. In the embodiment shown, the SPI for only site 112 is being calculated. Thus, site 112 data, which was identified and filtered using data pre-processor and analyzer 50, is input to SPI calculator 100. SPI calculator 100 may include a site data filter 501 as well as an analyzer block 510-550 for each factor category. SPI calculator 100 may also include weights and an aggregator 560 to aggregate the weighted factor choices. Finally, SPI calculator 100 may output SPI 595.

More specifically, site data filter 501 separates site 112 data into a type of data used to evaluate each factor, e.g., financial data, enrollment data, timeliness data, quality data, and experience data. Each of these data streams may be input to its respective factor category analyzer. For example, enrollment data may be input to enrollment analyzer 520, which then determines where the data falls statistically based on the enrollment factors used. For the factor “Site meets certain percentage of the Enrollment Target>50% of the time” (Enrollment Factor 2), enrollment analyzer 520 determines the enrollment targets for site 112 for each of the trials in which it has been involved and how well the site met the enrollment targets in those trials, and then determines in which percentile site 112's enrollment target falls>50% of the time. Other factors, such as Enrollment Factor 4, “Average FPFV LPFV compared to industry benchmark,” may use industry data 25 in addition to site and trial data.

Referring back to Enrollment Factor 2, in order to score the enrollment target percentile, the user or the system would assign a value for each percentile or grouping of percentiles—in FIG. 3B, Enrollment Factor 2 shows groupings less than 50%, 50-75%, 76-90%, and greater than 90%. In this embodiment, the lowest non-zero factor value (left column) for all of the factors in FIGS. 3A-3C is 5—which may be equivalent to a normalized weighting of 1. Since the factor value for Enrollment Factor 2 is 20, the weighting for that factor is 4 (20/5). In the embodiment of FIG. 3B, the weightings have already been applied on a per factor choice basis (explained later using FIG. 5B), but in another embodiment the unweighted choice values may be 0, 1, 4, 5. In this latter embodiment, if site 112 meets 50-75% of its enrollment target>50% of the time, the choice value would be 1, and this value would be output on the Enrollment Factor 2 line. Then, because Enrollment Factor 2 is weighted ×4, the value input to aggregator 560 would be 1×4=4. Similar analysis and calculations can be made for the other three enrollment factors and the other four factor categories shown in FIG. 5A using the data analyzers and weights in that figure.

FIG. 5B shows another embodiment of the SPI calculator, but only the enrollment analyzer and calculation are shown for ease of demonstration. This embodiment is the one shown in FIG. 3B, where the choice values are weighted somewhat differently than shown in FIG. 5A. Using the example of Enrollment Factor 2, in FIG. 5A, the unweighted choice values were 0, 1, 4, 5, so the weighted values would be 0, 4, 16, 20 (since this factor is weighted ×4). In FIG. 5B, the weighting is chosen so that individual factor choices may be more specifically weighted—that is, FIG. 3B shows that the weighted values are 0, 4, 17, and 20. Thus, the weighting may not be uniform across all of the choices within factor.

In FIG. 5B, the enrollment data stream is input to enrollment analyzer 520, just as in FIG. 5A. Enrollment analyzer 520 works just as before, analyzing the enrollment data to determine in which percentile site 112's enrollment target falls >50% of the time. If the answer is that site 112 meets 50-75% of its enrollment target>50% of the time, which is Choice 2 (see choice boxes 570), the choice value would be 4, just as it was in FIG. 5A. But if the answer is that site 112 meets 76-90% of its enrollment target>50% of the time, which is Choice 3, the choice value would be 17, which is one more than the 16 (4×4) that would have been calculated in FIG. 5A after weighting. Once the choice value is calculated, as with the embodiment of FIG. 5A, the value is input to aggregator 565, and the SPI may be calculated.

The blocks shown in FIGS. 1A, 1B, 5A, and 5B are examples of modules that may comprise system 10 and do not limit the blocks or modules that may be part of or connected to or associated with these modules. For example, there are likely many more than three trials and many more than three sites per trial whose data are stored in database 20. Database 20 may not be a single database, but may be an aggregate of separate or distributed databases, which may be connected via a network such as the Internet. Data pre-processor and analyzer 50 is shown separate from SPI calculator 100, but both modules could be physically part of the same software application. Moreover, although database 20 is shown connected to data pre-processor and analyzer 50, it may also be connected or accessible to SPI calculator 100. The blocks in FIGS. 1A, 1B, 5A, and 5B may be implemented in software or hardware or a combination of the two, and may include processors, memory, and software instructions executed by the processors.

The calculated SPI, based on these factors as well as factors not yet recognized, may be used to compare with the SPI of other sites to aid in site selection and site retention. An entity using the system to calculate the SPI may be able to quickly compare the SPIs for the different sites, and to select the site with the highest SPI. Such a comprehensive and realistic SPI includes more than just identifying sites that enroll an expected number of trial subjects or have investigators who, based on insurance claim data, may appear to treat the target patient population. Such a realistic SPI may also include more than just profile factors such as therapeutic area, years of experience, and facility type. The SPI is based on specific criteria that may be customized to take into account the criteria most important to the user. A further benefit of the calculated SPI of the present invention is that an entity involved in a clinical trial may be better equipped to understand the performance of the site, which may enable the entity to work with the site to increase the SPI.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

Referring to the data pre-processor and analyzer 50 and SPI calculator 100, in an embodiment, these modules may include a general-purpose computer and may have an internal or external memory for storing data and programs. The general-purpose computer may include a central processing unit (CPU) for executing instructions in response to commands, and a communication device for sending and receiving data.

In one embodiment, the network described above that may be used to upload data may include a communications interface that allows software and data to be transferred between a user's device, a processor, the other components shown in system 10, and ancillary systems such as EDC and CTMS. In this document, the terms “computer program medium” and “computer-readable medium” are generally used to refer to media such as a removable storage device, a disk capable of installation in a disk drive, and signals on a channel. These computer program products may provide software or program instructions to a computer system. The site performance index application may be installed on a user's mobile device.

Computer programs that may be associated with applications of site performance index calculator 100 (called computer control logic) may be stored in the main memory or secondary memory. Such computer programs may also be received via a communications interface. Such computer programs, when executed, may enable the computer system to perform the features as discussed herein. In particular, the computer programs, when executed, may enable the processor to perform the described techniques. Accordingly, such computer programs may represent controllers of the computer system.

In one embodiment, the computer-based methods may be accessed or implemented over the World Wide Web by providing access via a web page to the methods described herein. Accordingly, the web page may be identified by a Uniform Resource Locator (URL). The URL may denote both a server and a particular file or page on the server. In this embodiment, it is envisioned that a client computer system, which may be a user's device (not shown), may interact with a browser to select a particular URL, which in turn may cause the browser to send a request for that URL or page to the server identified in the URL. Typically, the server may respond to the request by retrieving the requested page and transmitting the data for that page back to the requesting client computer system, which may be the user's device (the client/server interaction may be typically performed in accordance with the hypertext transport protocol or HTTP). The selected page may then be displayed to the user on the user's display screen. The user's device may then cause the server containing a computer program to launch an application, for example, to perform an analysis according to the described techniques. In another implementation, the server may download an application to be run on the user's device to perform an analysis according to the described techniques.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A computer-implemented method, comprising:
receiving data from one or more clinical trial sites;
associating said clinical trial site data with at least one site performance factor;
calculating a weighting value for the site performance factor; and
generating a site performance index based on said weighted site performance factor.

2. The method of claim 1, further comprising receiving historic data and generating a site performance index based on the historic data.

3. The method of claim 1, further comprising filtering said clinical trial site data based on at least one filtering factor.

4. The method of claim 3, wherein the filtering factor is selected from the type of site, geography of the site, the claimed patient population for a given indication, clinical trial experience, and the specialty of the principal investigator.

5. The method of claim 1, wherein the generating a site performance index is performed in real time.

6. An apparatus, comprising:
a site data filter configured to separate data corresponding to a clinical trial site into at least one site performance factor category data stream,
each site performance factor category comprising at least one site performance factor,
each factor comprising at least one factor choice;
a data stream analyzer configured to analyze the site performance factor category data stream to determine a factor choice met for each site performance factor and to output a value for the determined factor choice, the determined factor choice being multiplied by a weighting value; and
an aggregator for aggregating the weighted, determined factor choices into a site performance index.

7. The apparatus of claim 6, wherein the factor takes into account historic data in addition to clinical trial site data.

8. The apparatus of claim 6, wherein the site performance factor category comprises financial data.

9. The apparatus of claim 6, wherein the site performance factor category comprises subject pool and enrollment history data.

10. The apparatus of claim 9, wherein the subject pool and enrollment history site performance factor category comprises a subject retention rate factor.

11. The apparatus of claim 10, wherein the subject retention rate factor choice is between 10% and 30%.

12. The apparatus of claim 6, wherein the weighting applies to the factor.

13. A computer-implemented method, comprising:
receiving data from one or more clinical trial sites;
filtering data corresponding to a clinical trial site;
identifying the performance of the clinical trial site in at least one clinical trial;
statistically analyzing the performance of the clinical trial site in the at least one clinical trial;
determining a site performance factor used to evaluate the clinical trial site;
calculating at least two factor choices to evaluate the clinical trial site;
analyzing the clinical trial site data and calculating which factor choice is met for the site performance factor;
outputting a value for the calculated factor choice; and
multiplying the calculated factor choice by a weighting value.

14. The method of claim 13, further comprising:
determining a second site performance factor used to evaluate the clinical trial site;
calculating at least one factor choice for the second site performance factor to evaluate the clinical trial site;
analyzing the clinical trial site data and calculating which second site performance factor choice is met for the second site performance factor;
outputting a value for the calculated second site performance factor choice;
multiplying the calculated second site performance factor choice by a weighting value; and
aggregating the weighted, calculated site performance factor choices into a site performance index.

15. The method of claim 13, further comprising further filtering said clinical trial site data based on at least one filtering factor.

16. The method of claim 15, wherein the filtering factor is selected from the type of site, geography of the site, the claimed patient population for a given indication, clinical trial experience, and the specialty of the principal investigator.

17. The method of claim 13, wherein the site performance factor is clinical trial experience.

18. The method of claim 13, wherein the site performance factor is average time from subject visit to data entry.

19. The method of claim 13, wherein the site performance factor is average number of system queries per subject.

20. The method of claim 13, wherein the site performance factor is the budget percentile into which the clinical trial site falls out of all sites compared to an industry benchmark.
